(19) United States
(12) Patent Application Publication
(10) Pub. No.: US 2007/0178022 A1
(43) Pub. Date: Aug. 2, 2007

(54) Analyte system

(76) Inventors: Noel C. Bauman, College Station, TX (US); Gary Erickson, College Station, TX (US); Greg Patterson, College Station, TX (US); Nate Rawls, College Station, TX (US); Richard K. Simon JR., College Station, TX (US); Kenneth Jiang, College Station, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(21) Appl. No.: 11/492,300

(22) Filed: Jul. 25, 2006

Related U.S. Application Data
(63) Continuation of application No. PCT/US06/02372, filed on Jan. 24, 2006.
(60) Provisional application No. 60/656,342, filed on Feb. 25, 2005.

(51) Int. Cl. B01J 19/00

(52) U.S. Cl. 422/130

(57) ABSTRACT

An improved analyte system where a temperature sensor and heater element combination are placed within a protective sheath. The sheath, temperature sensor, and heater element are placed within a reaction vessel so as to provide an internal heating source for reactive materials contained within the reaction vessel. The sheath extends through the reaction vessel into a reaction volume area of the vessel where an analytes-reagent reaction takes place. Further, the sheath is coated with a catalytic material, preferably platinum. The heater and sheath assembly may be introduced to any number of reaction schemes where reaction rate and detection acceleration is desired. The heater and sheath assembly works in conjunction with software to tune heating rates, optimum temperature, cooling rates, and detection analysis.

### BACKGROUND OF THE INVENTION

1. Field of the Invention

The present invention generally relates to an improved analyte system. More specifically, the present invention relates to a system where an analyte may be repeatedly heated and cooled, in an accurate and precise manner, to better effectuate analyte component quantitation.

2. Background Information

Systems for heating analytes of interest to effectuate quantitation of its components are known in the art. Generally, heating an analyte is desirable in so much as reaction rates increase and subsequent detection times decrease. Known heating systems have applied heat either through some external heating mechanism, such as a thermo-well, or have attempted to heat the analyte internally by placing a heating element within the reaction vessel itself. However, as will be discussed, systems heretofore known have had only limited success at best, particularly in view of the present system. As also will be discussed, one of the most useful and easily seen applications of the present system is in the context of carbon analysis.

There are several problems common to heating analytes and reagents, including those used in carbon analysis. These problems involve being able to precisely control temperature without overheating system components, being able to rapidly cool the reaction vessel, maintaining inertness of reaction vessel materials or heating elements, achieving proper drainage of the reaction vessel between reactions, minimizing water transfer from the reaction vessel, and minimizing reaction and detection times. What is needed, but has not come to fruition until now, is a system whereby an analyte-reagent mixture may be quickly heated within a reaction vessel in a precise manner, analyzed, and then efficiently drained from the reaction vessel so that a subsequent reaction can be induced. Moreover, the system must be sturdy enough to be used over and over again; it must be able to withstand corrosive materials it will be exposed to; and it must be low maintenance.

In a conventional carbon analysis system, whether it is a total inorganic carbon system (TIC), a total organic carbon system (TOC), or a total carbon system (TC), an analyte of interest is introduced into a reaction vessel and appropriate reagents are added. For example, in a TIC system, acid (e.g. phosphoric. acid, 5% vol: 100 mL) is typically added in excess to convert the inorganic carbon (present as carbonates) into carbon dioxide and inorganic chlorides. After sufficient reaction, the reaction vessel is purged by an appropriately scrubbed transport gas (typically nitrogen), which then passes through one or more drier elements, and finally passes through a detector calibrated for carbon dioxide. In a similar manner, a reaction vessel containing acid and persulfate solution (e.g. 100 g/L, 2000 mL) is used to convert an organic carbon species to carbon dioxide. As described above, the reaction vessel is purged by an appropriately scrubbed transport gas, passed through one or more drier elements, and finally passed through a detector. Ideally, a catalytic surface in combination with optimal reagent concentrations and analyte-reagent volumes at an optimal temperature is employed for analysis. This combination provides the best performance for quantitation efficiency, conversion efficiency, minimization of analysis time, and minimization of reagent consumption.

Constraints associated with the general processes described above relate to being able to achieve an accelerated reaction rate and complete oxidation in a preferably small window of time. If a reaction rate is too slow, the resulting effluent remains at a low concentration spread out over time, which ultimately limits quantitation of the content in the analyte. As such, reaction rate acceleration is of the utmost importance in carbon analysis, not only to maximize the number of samples being analyzed per unit time, but also to improve quantitation accuracy.

Attempts have been made, albeit with limited success, to accelerate the reaction rate by increasing reagent-analyte mixture temperature. However, known systems have been met with seemingly insurmountable problems in using this approach. As mentioned above, known systems have either employed use of an external thermo-well or attempted to place a heating element within the reaction vessel to bring about accelerated reaction rates. However, as to be further discussed, either approach has proven unsatisfactory.

As mentioned above, a TIC measurement requires the addition of a sufficient quantity of acid to convert all of the carbonates present to carbon dioxide. Temperature has little effect on the accuracy or speed of reaction. However, in the event a trace amount of persulfate remains in the reaction vessel after a TIC detection reaction, elevated temperatures may induce persulfate to react with organic carbon present in the sample. This will generate erroneous results, generally biased high. As a result, subsequent measurement of the organic content (i.e., total organic carbon) in the same sample (by addition of persulfate and heat) will result in an erroneously low value for the TOC measurement, since some of the organic carbon is detected in the previous TIC measurement (same aliquot). Sufficient reactor vessel cooling minimizes inadvertent oxidation by residual persulfate from the prior analysis. As such, it is extremely desirable to heat an analyte of interest in a single step and provide for quick and efficient assembly cooling between heating steps. One does not have to look hard to realize this repeated heating and cooling is difficult to achieve with the degree of precision required for reliable quantitative analysis.

Known analyte systems, including carbon analyzer systems, utilize specific reagents of specific concentrations and volumes to oxidize the organic species present in an analyte. Also, systems known in the art that apply heat do so by means of an external thermo-well or an internally placed heating element. When such is the case, temperature control is achieved by monitoring thermo-well temperature or monitoring analyte-reagent mixture temperature. As will be discussed, systems that rely on thermo-wells leave much to be desired with respect to efficiency and precision. Practical problems associated with internal heating all too often render such a technique not worth the effort.

Systems that employ a thermo-well generally require use of a thermal transfer fluid, such as silicone contact grease, to permit intimate coupling of the reaction vessel and thermo-well. This alone, and in combination with other limitations, presents a fundamental problem with cooling down the reactor vessel between reactions. Specifically, the sum thermal mass of the thermo-well, thermal coupling compound, and reaction vessel make efficient cooling of the reactor vessel extremely difficult. Due to the large thermal mass of the assembly, reaction vessel and thermo-well cooling takes too long. As such, the heating rate of the exterior thermo-well is slow and must be tuned for the minimum analyte-reagent volume so as to permit reliable operation. Moreover, the thermo-well, thermal coupling compound, reaction vessel assembly is contaminated by the thermal coupling compound itself. The thermal coupling compound, primarily silicone oil having very fine titanium oxide, is a mixture that spreads easily and readily coats all surfaces. Degradation of the thermal coupling compound results in air gaps, cracks, or voids, and reduces the effective transport of heat from thermo-well to reaction vessel.

Other attempts to heat an analyte-reagent mixture for improved quantitation have come by placing a heater within the interior of the reaction vessel itself. In practice, however, implementation problems have rendered these attempts all but useless. For instance, this technique requires careful analysis of thermal control requirements. Also, the heater itself must have an inert external surface that will not degrade when exposed to the aggressive oxidative and acidic nature of reagents used. These problems are compounded as incorporation of a temperature sensor directly within the heater element, and the proper positioning of the temperature sensor therein, has proven a difficult task. Improper placement of the temperature sensor results in the possibility of the analyte-reagent mixture coming to a vigorous “boil” before to the sensor can reflect the true temperature of the analyte-reagent mixture. This is especially true for sensor temperature set-points that are close to the boiling point.

Finally, attempts have been made to use catalytic materials to improve quantitative analysis. To date, however, attempts at placing a catalytic material within the reaction have been plagued by several problems. All to often placement of a catalytic material along the heating element surface creates undue heat transfer to the catalytic surface, thereby causing degradation. Also, residual fluid brought about by the catalytic material often negatively affects subsequent analysis.

### SUMMARY OF THE INVENTION

The general purpose of the present invention, which will be described subsequently in greater detail, is to provide an improved analyte system which has many of the advantages of such systems known in the art and many novel features that result in an improved analyte system which is not anticipated, rendered obvious, suggested, or even implied by any of the known systems, either alone or in any combination thereof.

In view of the above and other related objects, Applicant's invention provides a system that may perform within a larger scheme whereby a fluid mixture is placed within a reaction vessel to undergo a reaction and subsequent analysis. The present system is thought to be useful in any number of contexts where fluid heating is desired to effectuate improved analysis of that fluid, and as mentioned before, perhaps the most easily seen example of such is carbon analysis.

The present system provides a heater-temperature sensor combination internally placed within a reaction vessel. The sheath that surrounds this combination is coated with a catalytic material placed along the heating region of the sheath. As will be discussed, the use of novel components and the combination of those components, lends several novel attributes to the present system. For instance, successful placement of a temperature sensor and heating element within a reaction vessel, as taught herein, provides for much greater efficiency and precision in heating the analyte of interest. Internal placement of the heater and temperature sensor eliminates use of an external heater, and the inefficiencies associated therewith. Therefore, the system may be efficiently cooled between heating stages. Successful placement of a catalytic surface along an inert sheath, while avoiding problems typically associated with such, provides benefits with respect to reaction time and analysis. The benefits provided by this system are simply not available with systems known in the art.

The arrangement of each component, alone and in combination with the other provides a significant increase in the amount of analyte that can cycle through the system. Cycle time, or the number of analyses conducted per unit of time, is of great importance in almost all analyte systems. As mentioned, the present system is easily incorporated into a system for carbon analysis. For samples that require both TIC and TOC measurements, such as a TC analysis, cycle time includes the time required for cooling the reactor vessel to prepare for the next analyte.

As mentioned, TIC analysis is not strongly influenced by temperature. The primary reason for cooling the reactor vessel during analysis is the presence of trace amounts of un-reacted persulfate. The presence of residual persulfate could generate significant error in the TIC analysis as the persulfate partially oxidizes organic carbon. Since the rate of oxidation by persulfate is strongly temperature dependent, decreasing sample temperature from near 99 C (during the persulfate oxidation for TOC measurement) to 70 C or less (for the analysis of the next analyte for TIC) will decrease the amount of oxidized organic carbon by over an order of magnitude within the same TIC analysis time. During preferred system operation, the TIC sample is preheated to 70 C to prepare the analyte for the next measurement. This greatly minimizes the time required to heat the analyte to the persulfate oxidation temperature, generally between 95 C and 99 C.

At the start of the TIC cycle, the prior analyte-reagent mixture has just been drained, and nitrogen (or air) has been purged through the reactor vessel to aid in the draining process. Prior to initiating the drain step, the heater has been set to off, allowing the air purge to assist in cooling of the immersion heater. Next, a new aliquot of sample is introduced into the cell. The heat capacity of the aliquot loaded into the reactor vessel further cools the heater. Addition of the aliquot of acid and subsequent purging of the reactor vessel continues to cool the heater assembly to well below 70 C. The catalytic heater approaches room temperature if the reactor vessel was rinsed with de-ionized (ultra low carbon content-reverse osmosis) water.

Preferably, during system operation the heater is enabled to pre-heat the acid-analyte mixture to 70 C in preparation of (and during) the TIC measurement; this minimizes the time required to heat the analyte-acid-persulfate mixture between 95 C to 99 C for TOC measurement. At the end of TIC detection, the heater set point is set to 98 C (generally a preferred setting) and the persulfate aliquot is added. After addition of the persulfate, the system starts purgings the reactor vessel, transferring the carbon dioxide through the system as described above. Upon determination of the end of TOC detection, the analyte is drained, and prepared for the next analyte. If another replicate of the same sample is being analyzed, the reactor vessel may or may not be rinsed with DI/RO water. If a new sample (first replicate) is being analyzed, the reactor vessel is typically rinsed with DI/RO water.

Low wattage heaters are preferred as they are much less likely to overheat prior to injection of the acid and analyte. Such overheating could cause rapid expansion, pressure build up, and potential explosion or rupture of the reactor vessel or other system elements during the injection phase. However, with exercise of due caution, higher wattage heaters could be utilized to more rapidly heat the reactor vessel and analyte, acid, persulfate mixture. In its most preferred form, the heater element is designed to reach a maximum of 120 C to 200 C, all the while providing a significant margin for fail-safe operation. Additionally, software algorithms have been developed to optimize heating rates for various amounts of the analyte, acid, persulfate mixture for additional accuracy and optimum heating rate without overshoot or oscillation. The present system can be tuned with respect to specific analyte-reagent volumes to permit a faster heating reach the optimal temperature set point. However, this cannot be accomplished with the conventional external thermo-well approach.

### BRIEF DESCRIPTION OF THE DRAWINGS

Applicant's invention may be further understood from a description of the accompanying drawings, wherein unless otherwise specified, like referenced numerals are intended to depict like components in the various views.

FIG. 1 is a cross-sectional view of a reaction vessel of the system of the present invention.

FIG. 2 is a cross-sectional view of the preferred embodiment of the present system.

FIG. 3 is a cross-sectional of alternative embodiment of the present system.

FIG. 4 is a cross-sectional of yet another alternative embodiment of the present system FIG. 5 is a cross-sectional view of the preferred embodiment of the present system.

### DETAILED DESCRIPTION OF THE PREFERRED EMBODIMENT

The general steps and components of a system for TOC oxidation consists of basically four parts. The first of which is a sample inlet which may be accessed via a syringe, a sample loop, or a metering pump. Next is a reactor vessel which may contain one or more of the following elements: a heating element, a purge gas inlet, a purge gas outlet, a drain, an analyte inlet, an acid inlet, and an oxidant inlet. The system further consists of a drying element which may be a bulk condensation element using a passive heat sink, external air flow, refrigerated chambers, and Peltier cooled chambers, or a residual condensation element using a Nafion drier, Peltier cooling, and chemical sorbents. Finally, a detection system is required, which includes a carbon dioxide sensor, flow sensors, flow make-up control, and auxiliary detectors.

Although an oxidative process is shown by way of example, the present system is thought to be useful in any number of reactive systems where reaction rate and detection acceleration is desired. In such a system, heat is applied to an analyte-reagent mixture contained within a reaction vessel. Applicant's system is thought to improve this general scheme by providing for repeatable, accurate and precise heating of the aliquot. This, of course, accelerates reaction rates, promotes complete reaction, and decreases the time required for analysis. For example, the present system has been described as being particularly effective when used in conjunction with a carbon analysis system. In measuring the total carbon of an analyte, an analyte is acidified in accordance with TIC procedures described herein, persulfate is added immediately afterward, and the analyte in the reactor vessel is rapidly heated to between 95 C and 99 C. The purge gas agitates the solution and transports the liberated carbon dioxide from the reaction vessel through the remainder of the system. As will be discussed, use of a catalytic surface assists in increasing the rate of oxidation of the organic material in the analyte, and reduces the time required for analysis.

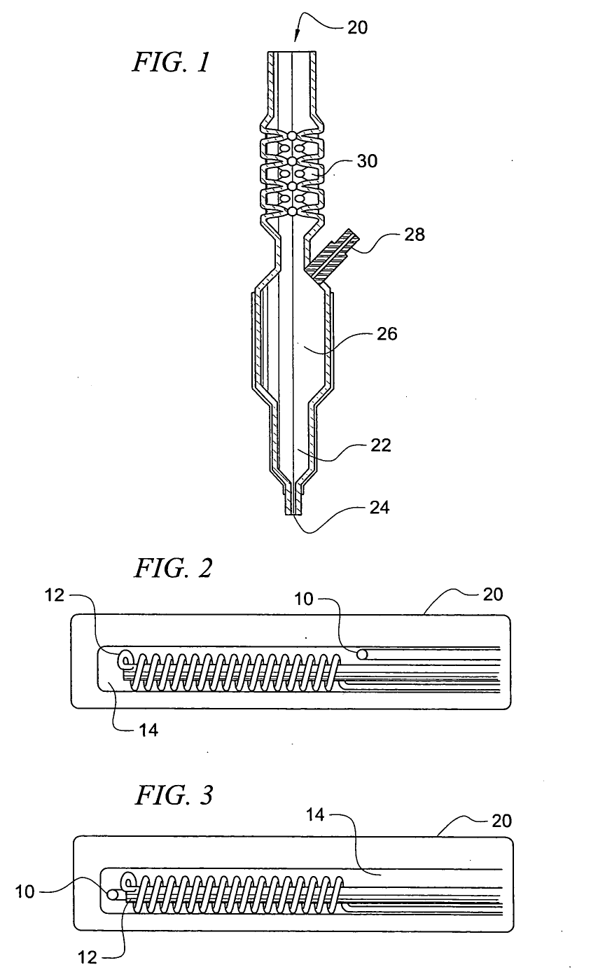

Referring to FIG. 1, a reactor vessel 20, with integrated expansion and bulk condensate drier volumes, is depicted. Reactor volume 22, located near the bottom portion of vessel 20 is where the primary components of the present system are preferably placed. As will be discussed, useful embodiments are envisioned where the interior surface of reactor volume 22 is coated with catalytic material. Along the bottom of vessel 20 is drainage port 24. Port 24 allows for drainage during the purge cycle of the reaction scheme. Above reactor volume 22 is expansion volume 26, which holds reaction products for a period of time. Sample inlet port 28 allows the analyte-reagent mixture to in be injected into vessel 20 for reaction. Finally, bulk condensate drier region 30 is located along the top portion of vessel 20 and provides for forced air cooling though the vessel.

Referring to FIG. 2, a heater element and temperature sensor combination according to the preferred embodiment is depicted. As shown, temperature sensor 10 extends within heater element 12, which extends within sheath 14. During operation, sheath 14 and its contents are substantially contained within reaction vessel 20. Temperature sensor 10 may be one of several types of sensors, such as a platinum resistance thermometer, thermocouple, positive temperature coefficient thermistor, or negative temperature coefficient thermistor. However, in the preferred embodiment, sensor 10 is a K-type thermocouple. Preferably, temperature sensor 10 is located along the lower end of heater element 12, extending from its lower surface and centrally aligned therewith.

As best seen in FIG. 3, particularly useful embodiments are envisioned where sensor 10 is not contained within heater 12, but is attached along external sheath 14 so as to provide for extra shielding, electrical isolation, or grounding. Moreover, alternate embodiments are envisioned where sensor 10 may be placed above, or between sections of, heater element 12. In such an embodiment, however, caution is required to ensure that the liquid level of the analyte-reagent mixture covers the heating element to ensure proper coupling of heat with the analyte.

Primarily referring to FIG. 2 and FIG. 3, in the preferred embodiment a catalytic material, preferably platinum covers the outer surface of external sheath 14 in proximity of temperature sensor 10 and heating element 12. Although many metal oxides are known to have catalytic ability with respect to accelerating oxidation of organic species, in general, the noble metals have been found to be the longest acting and most stable in aggressive acid-persulfate solutions. These metals include platinum, palladium, ruthenium, and iridium. These metals can be electrochemically plated onto heater sheath 14, and as such should be considered to be alternative approaches, with the preferred embodiment being that of platinum plating.

Sheath 14, in the preferred embodiment is, of inconnel-800 material. During operation, the catalytic coating of external sheath 14 provides for the catalytic surface being held at an optimum temperature for catalytic oxidation of organic carbon. Likewise, the catalytic coating assists in increasing the rate of oxidation of the organic material in the analyte, and it reduces the time required for analysis.

The novelty of the present invention is largely grounded in the quality of its catalytic coating along external sheath 14, and the method employed to achieve such. While it is well known to those skilled in the art that use of a catalyst certainly accelerates reaction rates, implementing an effective coating of such a catalyst has proven to be too difficult of a task. As such, known systems are unable to achieve results comparable to the present system. This catalytic coating, when applied as taught herein, provides benefits unavailable with systems known in the art.

Application of platinum to sheath 14, which in some embodiments is envisioned as having a ceramic surface such as alumina, can be accomplished by application of thick film platinum inks, platinum luster, or chemical vapor deposition. The Platinum inks preferably used are those made by Electro Science Laboratories, King of Prussia, PA, ESL-5544; the platinum luster preferably used is Bright Platinum #05 by Hanovia-Engelhart, of East Newark, NJ; and the chemical vapor preferably used is that of Silvex Surface Technology, of Westbrook, ME. The process for painting platinum luster or platinum thick film ink onto the ceramic surface, according to the present invention, is generally performed as follows: (1) clean surface with alcohol or acetone; (2) using a fine brush, paint the luster onto the desired surface area, applying an even, thin coat (less is best); (3) allow solvent to evaporate off, preferably for at least four hours; (4) place assembly into appropriate oven and ramp at 100 C per hour from room temperature, the solvent will bum off between 320 C and 420 C, then the oven must receive fresh air to allow fumes to escape, at approximately 600 C the bismuth-tin flux bonds, wetting the surface and allowing the platinum to adhere; (5) turn off oven (kiln) and allow it to slowly cool as safe handling temperature for the plating process is 200 C or lower-in case of doubt, allow the oven (kiln) to cool to room temperature before handling. In the event quartz or ceramic substrates are used, step (4) should include the following steps: continue to ramp up temperature to approximately 800 C for platinum luster, and approximately 1020 C for platinum ink, at this point the parts should be allowed to stand for 2 hours at temperature, for borosilicate glasses stop 25 C below the glass softening point and allow the heater elements to stand for 2 hours.

Placing the catalytic material within the reactor vessel according to the process described above avoids problems typically associated with catalytic material within the reactor vessel. More specifically, problems relating to heat transfer to the catalytic surface and draining the reactor vessel with no remaining residual liquid are avoided. After all, trace amounts of un-reacted persulfate solution can generate error with respect to the level of TIC within a sample (via oxidation of the some of the organic analyte during the TIC analysis cycle). This generates error with respect to the level of TOC within the same sample (due to loss of organic carbon in the prior TIC step).

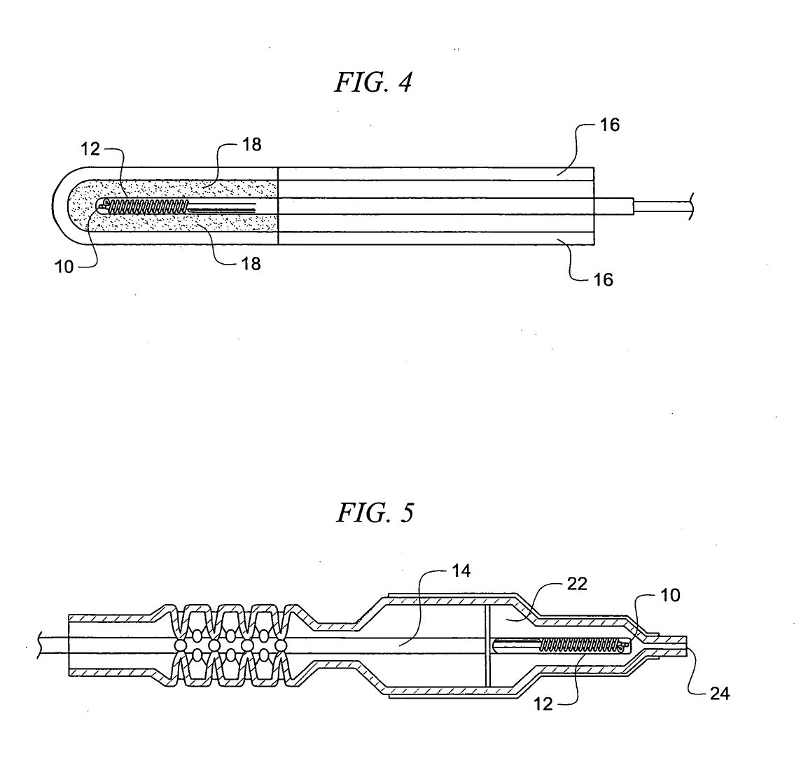

Referring primarily to FIG. 4, an alternative embodiment is shown where a catalytic surface is applied to thermo-well 16, using a quartz thermo-well design. Here, heater 12 is immersed within thermo-well 16. Thermally conductive fluid 18 is used to enhance heat transfer from heater 12, through fluid 18 and thermo-well 16, into reactor vessel 20. However, the catalytic surface is placed on the exterior wall of the thermo-well 16, and readily fabricated according to the process regarding a ceramic body heater using either platinum inks or platinum lusters. In the preferred embodiment, thermally conductive fluid 18 is Dynalene HT, made by Dynalene Heat Transfer Fluids, of White Hall, Pa. Useful embodiments are envisioned where the addition of copper powder to Dynalene HT significantly increases the rate of heat propagation through heat transfer fluid 18. In some respects, applying the catalytic surface to thermo-well 16 is preferred in so much as it has an extremely smooth surface, is highly inert, and allows the analyte-reagent mixture to leave the platinum surface with little or no residual liquid retention along the surface. However, it should be noted that care should be taken to seal the top of thermo-well 16 to heater assembly to prevent leakage of the conductive fluid 18.

Another alternative embodiment is depicted in FIGS. 5. FIG. 5 depicts a system for catalytic oxidation of an analyte of interest, perhaps organic carbon, using a “wet” oxidation technique. The catalytic surface coats the interior wall of reactor vessel 20, where the catalytic coating extends above the level of the analyte-reagent mixture. In this case, heater 12 is preferably placed within the interior of vessel 20 as shown in FIG. 6; however, operation also envisioned where heater 12 is external to vessel 20.

Finally, a reaction system that may benefit though incorporation of the present system is presented as follows:
1. Prime sample.
2. Aspirate reagent (acid).
3. Inject sample and reagent (gas off liquid carrier).
4. Heat reactor vessel to TIC react temperature (70 C).
5. Hold reactor vessel at TIC react temperature for TIC react time (1-3 minutes).
6. Turn valves to TIC detect positions; heat to TIC detect temperature; and sparge reactor vessel with carrier gas.
7. Detect TIC with NDIR.
8. Complete TIC detect (end of peak detected, or time-out).
9. Reset valves for TOC react.
10. Aspirate persulfate reagent.
11. Heat to TOC react temperature.
12. React for TOC react time (1-4 minutes).
13. Turn valves to TOC detect position; heat to TOC detect temperature; and sparge reactor vessel with carrier gas.
14. Detect TOC with NDIR.
15. Complete TOC detect (end of peak detected, or timed-out).
16. Drain.
17. Rinse.

Although the invention has been described with reference to specific embodiments, this description is not meant to be construed in a limited sense. Various modifications of the disclosed embodiments as well as alternative embodiments of the inventions will become apparent to persons skilled in the art upon the reference to the description of the invention. It is, therefore, contemplated that the appended claims will cover such modifications that fall within the scope of the invention.

We claim:

1. An analyte system, comprising:
a reaction vessel;
a protective sheath, said protective sheath being coated with a catalytic material, said protective sheath being configured for insertion into said reaction vessel;
a heating element, said heating element being configured within said protective sheath; and
a temperature sensing means, said temperature sensing means being configured within said protective sheath.

2. The system of claim 1 wherein said temperature sensing means is centrally aligned within said heating element.

3. The system of claim 1 wherein said temperature sensing means is positioned externally to said heating element.

4. The system of claim 1 wherein said catalytic material is selected from the group consisting of platinum, palladium, ruthenium, and iridium.

5. The system of claim 4 wherein said catalytic material is applied via a method comprising the steps of:
cleaning the surface of said protective sheath with alcohol or acetone;
applying a thin, even coat of said catalytic material containing a solvent onto said protective sheath using a fine brush;
allowing said solvent to evaporate at room temperature,
placing in an oven at room temperature;
ramping the temperature of said oven at 100 C per hour until said catalytic material adheres; and
turning off said oven and allowing said protective sheath to cool.

6. The system of claim 4 wherein said catalytic material is applied via a method comprising the steps of:
cleaning the surface of said protective sheath with alcohol or acetone;
applying a thin, even coat of said catalytic material containing a solvent onto said protective sheath using a fine brush;
allowing said solvent to evaporate at room temperature;
placing in an oven at room temperature;
ramping the temperature of said oven at 100 C per hour until said catalytic material adheres;
allowing said protective sheath to stand at substantially 1020 C for at least 2 hours; and
turning off said oven and allowing said protective sheath to cool.

7. The system of claim 1 wherein a portion of said reaction vessel is coated with a catalytic material.

8. The system of claim 7 wherein said catalytic material is selected from the group consisting of platinum, palladium, ruthenium, and iridium.

9. An analyte system, comprising:
a reaction vessel;
a thermowell, said thermowell being coated with a catalytic material, said thermowell being configured for insertion into said reaction vessel;
a thermally conductive fluid, said thermally conductive fluid being contained within said thermowell;
a heating element, said heating element being configured for immersion within said thermowell; and
a temperature sensing means, said temperature sensing means being configured for immersion within said thermowell.

10. The system of claim 9 wherein said temperature sensing means is centrally aligned within said heating element.

11. The system of claim 9 wherein said temperature sensing means is positioned externally to said heating element.

12. The system of claim 9 wherein said catalytic material is selected from the group consisting of platinum, palladium, ruthenium, and iridium.

13. The system of claim 12 wherein said catalytic material is applied via a method comprising the steps of:
cleaning the surface of said thermowell with alcohol or acetone;
applying a thin, even coat of said catalytic material containing a solvent onto said thermowell using a fine brush;
allowing said solvent to evaporate at room temperature;
placing in an oven at room temperature;
ramping the temperature of said oven at 100 C per hour until said catalytic material adheres; and
turning off said oven and allowing said thermowell to cool.

14. The system of claim 12 wherein said catalytic material is applied via a method comprising the steps of:
cleaning the surface of said thermowell with alcohol or acetone;
applying a thin, even coat of said catalytic material containing a solvent onto said thermowell using a fine brush;
allowing said solvent to evaporate at room temperature;
placing in an oven at room temperature;
ramping the temperature of said oven at 100 C per hour until said catalytic material adheres;
allowing said thermowell to stand at substantially 1020 C for at least 2 hours; and
turning off said oven and allowing said thermowell to cool.

15. The system of claim 9 wherein a portion of said reaction vessel is coated with a catalytic material.

16. The system of claim 15 wherein said catalytic material is selected from the group consisting of platinum, palladium, ruthenium, and iridium.
